(19) United States
(12) Patent Application Publication
(10) Pub. No.: US 2024/0233560 A1
(43) Pub. Date: Jul. 11, 2024

(54) SYSTEMS AND METHODS FOR DETECTING ANOMALOUS AIRCRAFT FLIGHTS FROM SURVEILLANCE DATA

(71) Applicant: BigML, Inc., Corvallis, OR (US)

(72) Inventors: Ken Baldwin, Albany, OR (US); Rick Hangartner, Corvallis, OR (US); Jim Shur, Barcelona (ES); Chee Sing Lee, Bangor, ME (US); Poul Petersen, Corvallis, OR (US); Charlie Parker, Lake Bluff, IL (US); Francisco Martin, Corvallis, OR (US)

(21) Appl. No.: 18/154,732

(22) Filed: Jan. 13, 2023

Related U.S. Application Data
(60) Provisional application No. 63/299,803, filed on Jan. 14, 2022.
(60) Provisional application No. 63/299,808, filed on Jan. 14, 2022.

(51) Int. Cl. G08G 5/00; G06N 20/00

(52) U.S. Cl. CPC G08G 5/0082; G06N 20/00; G08G 5/0026; G08G 5/0043

(57) ABSTRACT

A machine learning system is provided that receives location information from one or more aircraft, determines a deviation of the actual aircraft flightpath from an expected flight path. The flight path may be determined based on a filed flight plan, one or more historical flight paths. The actual aircraft flightpath is scored with respect to the expected flight path and the score may be used to determine an anomalous condition. In some cases, an aircraft crossing a boundary creates the anomalous condition. The anomalous conditions may be used to create a flag or an alert to indicate further analysis may be required. Through machine learning algorithms, hundreds, thousands, or tens of thousands or more flights can be simultaneously tracked and analyzed for anomalous conditions.

### CROSS-REFERENCE TO RELATED APPLICATIONS

This application claims the benefit under 35 U.S.C. § 119(e) of U.S. Provisional Patent Application No. 63/299,803, filed Jan. 14, 2022, entitled “SYSTEMS AND METHODS FOR DETECTING ANOMALOUS AIRCRAFT FLIGHTS FROM SURVEILLANCE DATA” and U.S. Provisional Patent Application No. 63/299,808 filed Jan. 14, 2022, entitled SYSTEMS AND METHODS FOR EFFICIENTLY DETECTING ANOMALOUS LOCATIONS FROM POSITIONAL DATA,” the contents of which are incorporated herein by reference in their entirety.

### GOVERNMENT LICENSE RIGHTS

This invention was made with Government support under contract number FA864921P0851 awarded by the USAF RESEARCH LAB. The Government has certain rights in the invention.

### BACKGROUND

Each day there are approximately 50,000 flights in North American airspace. Despite efforts to modernize national security over the past twenty years, detecting possible threats from one or more of these flights is still left to human operators to determine a potential threat and to initiate action against the threat.

It would be advantageous if at least some of the monitoring, threat assessment, and notification could be automated. These, and other advantages, will become apparent to those of skill in the art by reference to the following description and appended figures.

### SUMMARY

According to some embodiments, a system and method are described that are configured to track up to all of the aircraft flights within the North American airspace, and in some cases, are configured to track all of the aircraft flights within a specified geographic boundary. In some cases, the system is scalable to track all of the flights around the world. The system and methods are configured to provide a real-time or at least near real-time analysis of the aircraft flight data and determine a threat level of each aircraft based upon anomalous predefined measures, such as a deviation from a flight plan, deviation from a historical flight route, violation or the probability of violation of protected airspace, anomalous behavior, among other things. The system is configured to enrich the flight data and determine a threat score for tens of thousands of simultaneous aircraft flights at a time interval, such as every 1 second, 10 seconds, 60 seconds, or more. The system and method are further configured to display and surface the top threats to a user for additional action. In some cases, the system is able to generate an alert and/or generate instructions for responding to the alert where one or more aircraft have a threat score that exceeds a threshold.

According to some embodiments, a method for determining aircraft threats includes the steps of receiving flight data associated with one or more aircraft; extracting and enriching the flight data; training machine learning (ML) models on the flight data; determining flight route propensities; determining a threat score; generating an alert where a threat score exceeds a threshold; and displaying the threat score and the alert on a user interface.

The method may include receiving one or more of Automatic Dependent Surveillance-Broadcast (ADS-B) data, filed flight plan data, and Federal Aviation Administration tables. In some cases, enriching the flight data includes adding one or more of an aircraft location, an aircraft type, an engine type, and aircraft performance characteristics to the flight data. The method may determine the flight route propensities by using Bayesian classifier. The machine learning (ML) models may be trained with an ML model unique to a combination of an aircraft type and an engine type. Thus, hundreds, or even thousands, of unique ML models may be created and trained.

In some embodiments, receiving flight data associated with one or more aircraft comprises receiving flight data on a time interval for an operating flight, such as every 10 seconds. In addition, receiving flight data associated with one or more aircraft may comprise receiving flight data for over 1000 aircraft simultaneously. In some examples, determining a threat score is performed in near real time. As used herein, the phrases “real time” and “near real time” are broad phrases and are used to refer to outputting the output data as quickly as practicable given delays and latencies associated with transmitting large quantities of data over long distances and processing the data by a specially configured computer system that is configured with instructions to extract and enrich the flight data, perform machine learning classification and predictions related to flight plan adherence and route propensities, and determine a threat score. In some cases, the system described herein are capable of determining a threat on thousands of aircraft simultaneously such that the actionable intelligence is provided to a user within seconds, or less, of the data being received.

In some cases, extracting and enriching the flight data comprises generating Kafka topics.

The methods and systems herein result in a continuous threat scoring pipeline that is capable of determining potential threats from aircraft based on the aircraft behavior and probabilistic determinations of likely future events.

### BRIEF DESCRIPTION OF THE DRAWINGS

The accompanying drawings are part of the disclosure and are incorporated into the present specification. The drawings illustrate examples of embodiments of the disclosure and, in conjunction with the description and claims, serve to explain, at least in part, various principles, features, or aspects of the disclosure. Certain embodiments of the disclosure are described more fully below with reference to the accompanying drawings. However, various aspects of the disclosure may be implemented in many different forms and should not be construed as being limited to the implementations set forth herein. Like numbers refer to like, but not necessarily the same or identical, elements throughout.

The following drawing figures, which form a part of this application, are illustrative of described technology and are not meant to limit the scope of the technology as claimed in any manner, which scope shall be based on the claims appended hereto.

FIG. 1 illustrates a block diagram of a process flow, in accordance with some embodiments.

FIG. 2 illustrates a sample flight plan of an aircraft, in accordance with some embodiments.

FIG. 3 illustrates a real-time aircraft anomalous scoring pipeline, in accordance with some embodiments.

FIG. 4 illustrates a heat map of the normalized propensity measure aligned across regions, in accordance with some embodiments.

FIGS. 5A and 5B illustrate a continuous ML model retraining pipeline, in accordance with some embodiments.

FIG. 6 illustrates a block diagram of flight data input and an example front end for displaying the flight data with threat scores, in accordance with some embodiments.

FIG. 7 illustrates a sample user interface of a threat feed view of an EDT system, in accordance with some embodiments.

FIG. 8 illustrates a sample user interface of a Top Threat View of the EDT system, in accordance with some embodiments.

FIGS. 9A and 9B illustrate an example expanded view of the EDT system showing additional detail on the aircraft threat score, in accordance with some embodiments.

FIG. 10 illustrates an example EDT system architecture, in accordance with some embodiments.

FIG. 11 illustrates a sample process flow for determining a threat score of an anomalous aircraft, in accordance with some embodiments.

### DETAILED DESCRIPTION

According to some embodiments, an intelligent automated system is configured to help operators filter the tens of thousands of flights occurring each day to identify possible threats. The field of the present disclosure is related to, among other things, automatically determining, through the monitoring and analysis of various data sources, anomalous aircraft flights.

Embodiments of the Early Detection of Threats (EDT) framework, as described herein, provide a scalable, real-time machine learning (ML) based early warning and detection system to empower operators to identify such threats across millions of miles of airspace.

Accurately monitoring thousands of flights in the air at any time for possible threats is a huge challenge for human operators. The goal of EDT is to automatically process flight data and assist operators by providing an easy to interpret, ML-based threat score for each active flight that address two essential questions: (1) is the flight behaving normally for an aircraft of that type, and (2) is the flight where it is supposed to be relative to a flight plan and historical flight patterns.

High scoring flights can be surfaced to operators for further review, enabling them to monitor air traffic in a secure, efficient and accurate manner. Threat scores may include explanatory information, indicating in what way a flight is anomalous, thus aiding further analysis.

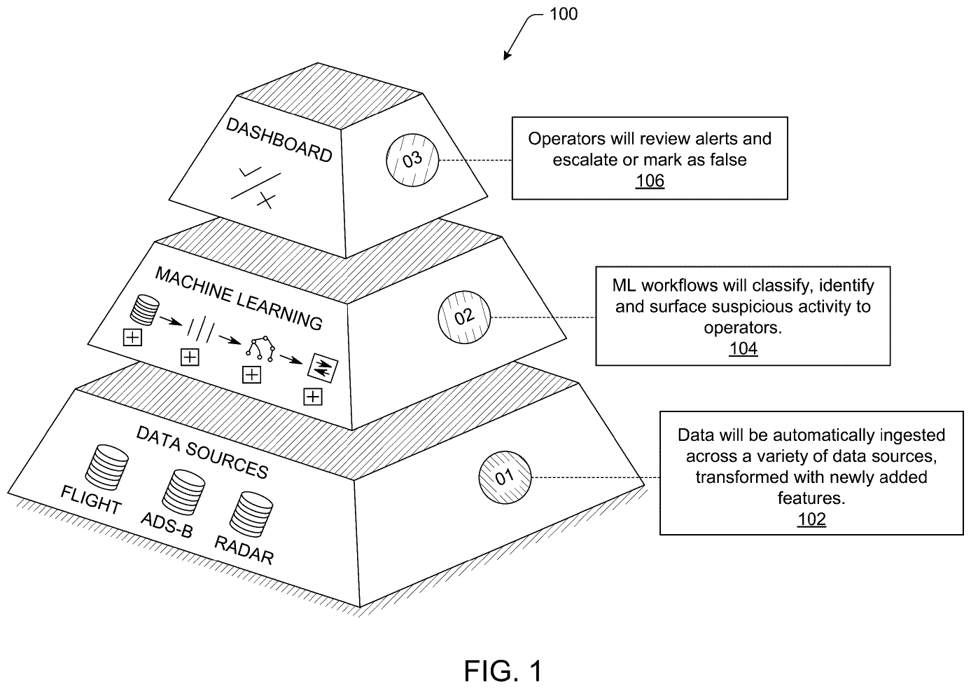

FIG. 1 illustrates a high-level overview of the EDT system hierarchy 100. At a first level 102, data may be automatically ingested across a wide variety of data sources and can be transformed with newly added features. As an example, data sources may include one or more of Automatic Dependent Surveillance-Broadcast (ADS-B) information which is information transmitted by an ADS-B transponder on-board an aircraft, GPS position data, radar tracking data, historical flight path data, filed flight plan data, among others.

At a second level 104, machine learning (“ML”) workflows are configured to classify, identify, and surface suspicious activity to operators. The classification schema may be any suitable method, including those described hereinbelow, and may compare flight tracks of real time aircraft position data against historical flight paths, planned and filed flight paths, and/or flight paths relative to known obstacles, hazards, restrictions, etc. For example, where an aircraft flight path indicates that the aircraft may fly into a temporary flight restriction area (“TFR”), an alert may be generated to bring the offending aircraft to the attention of an operator tasked with viewing and escalating alerts and initiating corrective action.

At a third level 106, operators may review alerts and escalate or mark alerts as false. In some cases, the operator is presented with a threat score which may indicate the severity of the aircraft anomaly. Further, the EDT system may recommend that a certain action be taken, or in some cases, the system may automatically initiate a corrective action based on the threat score.

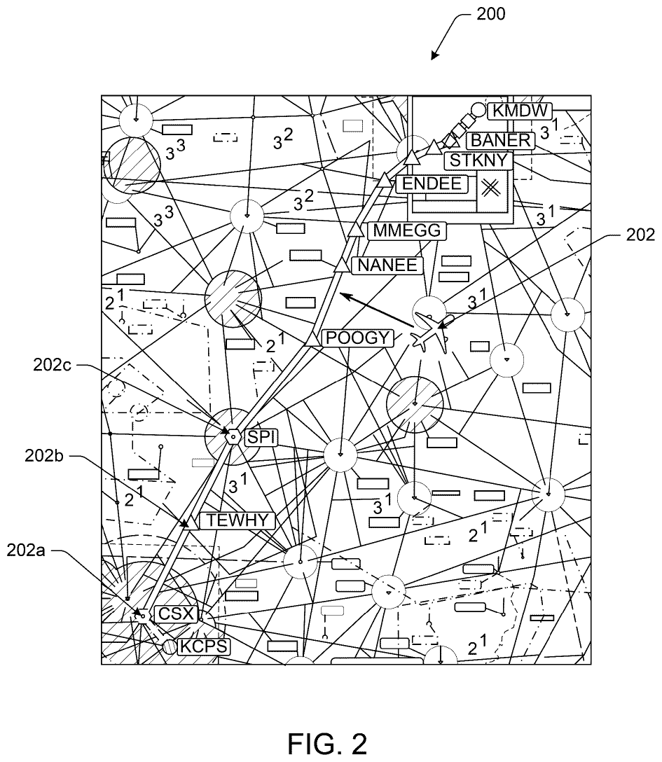

FIG. 2 illustrates a flight plan of an aircraft 200 and an aircraft 202 that has deviated from the flight plan. In many cases, aircraft are required to file flight plans if the aircraft will be flying under instrument meteorological conditions (IMC) and will thereby follow the instrument flight rules (IFR). In addition, all aircraft flying in Class A airspace, that is, at altitudes from 18,000 feet mean sea level (MSL) up to and including flight level (FL) 600, and also including the airspace overlying the waters within 12 nautical miles of the coast of the 48 contiguous states and Alaska. Unless otherwise authorized, all operation in Class A airspace is conducted under IFR and the aircraft operator must file a flight plan. FIG. 2 illustrates an example IFR flight plan in which designated waypoint 204a, 204b, 204c, etc. are specified along with prescribed altitudes. By having prescribed routes and altitudes, air traffic controllers have a much easier job of maintaining separation between aircraft operating within the airspace.

Moreover, in general, aircraft flying magnetic headings between 0° and 179° under IFR will fly at an altitude that is an odd thousand feet (e.g., 15,000 ft, 21,000 ft, 29,000 ft, etc.) and aircraft flying on a magnetic heading between 180° and 359°, will fly at an altitude that is an even thousand feet (e.g., 12,000 ft, 18,000 ft, 22,000 ft, etc.). Above FL290, additional rules apply, but it is sufficient to note that there are prescribed altitudes for aircraft based upon their magnetic course heading.

In some cases, the EDT system 100 may determine that an aircraft has deviated from their flight plan, either by not following the planned route, or by not adhering to a prescribed altitude, or both. In these cases, the EDT system 100 may generate an alert to notify an air traffic controller (ATC) of an aircraft deviation which may require closer scrutiny of the deviating aircraft.

Aircraft flying under visual flight rules (VFR), have similar assigned altitudes above 3,000 feet, and in some cases, may file VFR flight plans, though not typically required. An aircraft flying under VFR may also be flagged by the EDT system 100 as deviating from an expected flight path, altitude, or approaching a TFR or other type of special use airspace (e.g., military operations areas (MOAs), prohibited areas, restricted areas, warning areas, controlled firing areas (CFAs), and alert areas).

In some cases, the EDT system 100 is a high-performance, Kafka based event processing pipeline capable of scoring flights in real time and at scale to match the unique flights within an area, country, or continent. Apache Kafka is an open-sourced distributed event streaming platform and is able to provide a unified, high-throughput, low-latency platform for handling real-time data feeds. While the system is described as a Kafka-based system in many embodiments herein, any suitable platform that offers high-throughput and low-latency handling of real time data feeds may be used with the systems and methods described herein. For efficiency of description, the Apache Kafka system is used as an example, and not limiting, platform.

Flights may be scored at multiple timescales, ranging from 10 seconds to 10 minutes, and the scores may be combined into an overall current threat score. In some embodiments, highly computationally efficient ML workflows are configured to detect suspicious flight behavior. The EDT system 100 is configured to be scalable to process huge volumes of flight data (e.g., more than 10,000, 20,000, 50,000, 100,000, or 500,000 or more simultaneously). Of course, as computing power and speed increases, the volumes of flight data able to be simultaneously processed also increases and the throughput is given as an example, and not limitation, of the described systems and methods.

In some cases, numerous (e.g., hundreds) of ML models may be employed wherein each ML model may be specific to a particular aircraft type and engine type, and may be trained and activated into the scoring pipeline as part of a fully-automated ML workflow. In some cases, the ML models are continuously trained and their ability to accurately score threats improves over time. In some embodiments, traceability is maintained so that an audit of a particular scoring event can recover the specific model used and the data with which it was trained. The traceability may be provided by storing the training data, ground truth data, and data input/output on a server or distributed computing environment so that the data is archivable and retrievable.

In some cases, real-time threat scores may be published as Kafka topics, which are a dedicated and fundamental unit for event or message organization. Kafka topics therefore represent virtual groups or logs that hold data and events in a logical order, allowing users or other systems to send and receive data between Kafka servers with efficiency. In some cases, a Kafka topic allows easy integration with other system, such as, for example, the N2X system developed and marketed by Agilent Technologies, which is an infrastructure emulator that includes a system controller and multiple chassis for purpose-built test cards for testing environments. In addition, a web-based front end may be provided for visual threat monitoring, inspection, debugging, and evaluation of the EDT system.

### Data Sources

The Automatic Dependent Surveillance-Broadcast (ADS-B) system broadcasts information about an aircraft's GPS location, altitude, ground speed, flight direction, and other data to ground stations and other aircraft, approximately once per second. In some embodiments, the EDT system 100 may access ADS-B data by consuming a composite radar tracker stream, which are published by a number of vendors, and filtering for points which contained an ADS-B target ID.

The EDT system 100 scoring pipeline may be implemented as a series of Kafka Streams applications (app), which, in some cases, may require that all input data streams be topics within the local Kafka cluster. Therefore, in some cases, the EDT system 100 mirrors all the data sources locally, which allows for the local Kafka data retention time to be set independently of the original data source, for possibly longer data accumulation.

In some cases, the ADS-B data is provided as a different source format and the EDT system 100 is configured to translate the incoming data into an acceptable format, such as a Kafka topic for further consumption and processing.

Another form of data source may be flight plans. In some cases, the EDT system 100 is configured to consume flight plan data, which may be published by any of a number of providers, and may be provided as a Kafka topic. This data stream contains messages that describe the flight plan of the real-time flights described in the ADS-B data. In some cases, flight plan data is published hours, or even days, before the actual flight, and multiple messages must typically be collated into a final form, an offline process may compile the data into a usable form for processing real-time flight data.

In addition to the real-time data described above, another source of data may be a Federal Aviation Administration (“FAA”) database table that may include aircraft registry, airports, and waypoints. The aircraft registry data may further include aircraft type, registration number, engine type, manufacturer, and model. The airport data may include the airport identifier, latitude and longitude coordinates, and other information, such as time of operation, approach and/or tower frequencies, airspace classifications, and others. The waypoints data may additionally include the name of the waypoint, the latitude and longitude coordinate of the waypoint, and an approach or departure route that is typically associated with the waypoint.

### Flight Scoring

According to some embodiments, the EDT system 100 provides a system configured to score flights in real time and at scale. In some cases, flights are scored at multiple time scales, such as 10 seconds to 10 minutes, and any interval in between. In some cases, the scores are combined into an overall, current threat score.

According to some embodiments, the primary EDT system 100 scoring pipeline is implemented as a series of Kafka Streams applications, which transform input Kafka topics into output Kafka topics. In some cases, this allows real-time streaming applications to be written concisely, in a way that is distributed and fault-tolerant.

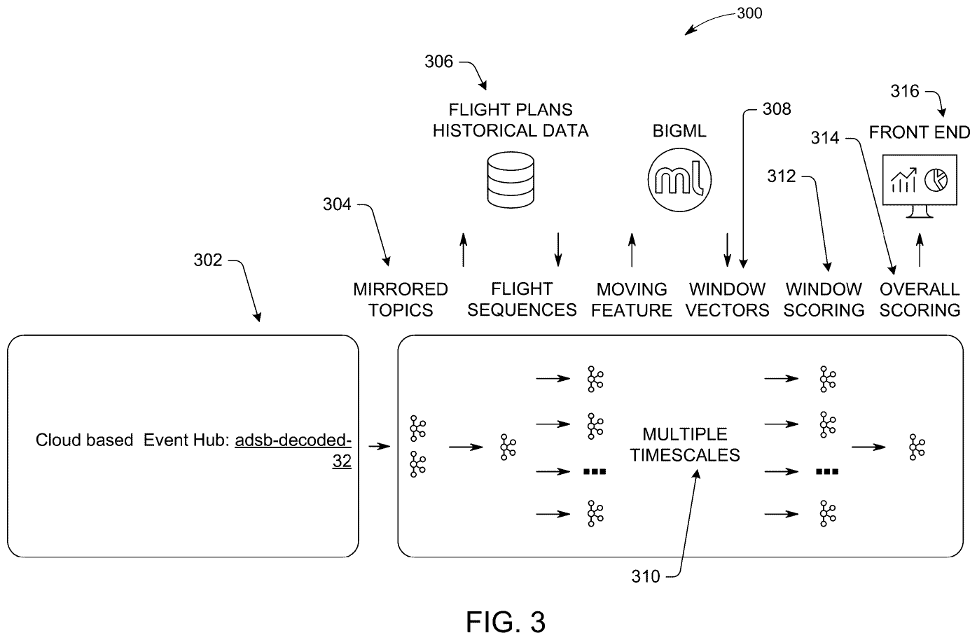

With reference to FIG. 3, a scoring pipeline 300 is illustrated. The streams pipeline includes digesting the ADS-B input data streams 302 and in some cases, performs at least two tasks: data extraction and data enrichment. The input to the data extraction and data enrichment Kafka Streams application, in some cases, is the mirrored Kafka topic 304 and the output may be published as a new Kafka topic.

The data extraction from the ADS-B data may include ID fields and kinematic variables, among others. This allows the Kafka stream to use flight plans historical data 306 in determining aircraft flight characteristics. The ID fields may be used to reference a signal event, which may be carried through the scoring pipeline 300. The ID fields may include one or more of an ADS-B target ID, ADS-B target address, timestamp. In some cases, the ADS-B target ID is a unique identifier and may be used as a key for downstream grouping and scoring operations. The timestamp may be used for windowing the ADS-B data by time 308. In some cases, the kinematic fields from the ADS-B messages describe the aircraft position and behavior, and may be the basis for determining whether the aircraft is behaving normally for that type of aircraft. In some cases, the position and behavior may include latitude and longitude, altitude, speed, and heading, along with a rate of change of any of these values, among other things.

The data enrichment may add additional fields to the ADS-B data stream 302, which may provide additional information about the aircraft, which in some cases are derived from the FAA registry table. These additional fields may include aircraft type, engine type, aircraft model, and manufacturer, among other data fields. In some embodiments, the aircraft and engine type may be used for model granularity and the EDT system 100 may train models specific to each combination. Additional fields, such as aircraft manufacturer and model may be carried through the process for display purposes. Additional fields may be added to describe the location of the aircraft and a deviation from flight plan measure may be added to describe any deviation from the flight plan. In some cases, the deviation from flight plan measure may comprise the closest distance from the aircraft to a piecewise linear interpolation through the flight plan waypoints. In some examples, a pair of flight propensity measures may describe the likelihood of seeing a flight at the current location, which may be based on historical reference data.

Feature Generation is the process of consuming the enriched data streams and producing ML-ready feature vectors that can be used in model training and scoring. In some embodiments, feature generation groups messages by a key, such as the ADS-B target ID, and may also window messages based on time. In some cases, windows may be computed at varying timescales 310, such as at one or more of 1 second, 5 seconds, 10 seconds, 20 seconds, 30 seconds, 1 minute, 2 minutes, 3 minutes, 5 minutes, 10 minutes, or more. In some cases, a separate Kafka Stream may be deployed for each of the unique time scales. According to the time scales, features are computed which describe the distribution of a particular value, such as altitude, for example, within a given window 312. In some cases, more than one distribution is used, such as the base value itself, and a set of deltas which describe the difference between successive values over time (e.g. dx/dt). In some cases, the delta distribution gives information about the rate of change of a variable. In some cases, basic distribution statistics may be computed for both distributions, and may include one or more of a minimum, maximum, mean, standard deviation, kurtosis, and skewness.

In some embodiments, implementation of these statistics compute values in either streaming and/or batch mode, and which use either on-disk or in-memory temporary storage, which may provide flexibility based on deployment requirements. In some cases, the temporary storage is converted to more permanent storage, which in some cases, allows for later review of the raw data inputs for subsequent review and analysis.

In some examples, a Kafka message (e.g., BIGML.FLIGHT.JSON) includes up to six or more values, some of which may be extracted from the ADS-B message and some of which may be added during enrichment. The JSON stands for JavaScript Object Notation and is generally a lightweight format for storing and transporting data, and is an efficient way of storing and sending Kafka messages. While the description herein uses Kafka messages and the JSON format, these are used as examples only and it should be apparent that other types of architectures, file formats, and platforms can be used without departing from the spirit and scope of the described systems and methods. Examples of these values may include one or more of altitude, speed, heading, plan deviation, refNaiveBayes, and refNormalized. In some embodiments, six numeric variables, six statistical variables, and two distributions (such as base values and delta values) combine to produce 72 numeric features in the output message.

According to some embodiments, timescale scoring is the process of computing threat scores for the real-time feature vectors. Timescale Kafka Streams scoring apps may be deployed and may be associated with each timescale. For example, a Kafka Streams scoring app may consume a timescale feature topic, such as, for example, BIGML.FEATURE.1MIN.JSON, and may be published to a corresponding timescale scoring topic, such as, for example, BIGML.SCORE.1MIN.JSON. According to some embodiments, the ML models used for scoring are anomaly detectors, which may be trained using the BigML VPC (described later herein) and in some cases, may be downloaded locally.

In some cases, each scoring application (app) maintains an in-memory model cache. For example, given a feature message for a particular timescale (20SEC, for example) for a given aircraft and engine type, a scoring application may first look for the model in the cache. If found it may use that model for scoring; otherwise, it may attempt to load the model from a storage location. In successful, the application uses the newly-loaded model for scoring and may add it to the cache. In some cases, where a matching model cannot be located, a series of fallbacks may be performed to find the best available model. If no other match is found, in some cases, a default model may be used for the given timescale, trained on data from all aircraft and engine types which have not yet accumulated enough data to train a dedicated model. However, over time, and as additional models are created, it is expected that very few models will be unavailable.

In some cases, the in-memory model cache uses a time-to-live (TTL) policy of one house, so models may periodically expire from the cache. This TTL expiration allows models to be removed from the cache that are no longer needed, such as when no aircraft of that type remain in the air, and to periodically require loading models from storage, so any newly trained models will be loaded.

According to some embodiments, when a scoring application scores an input feature message, it may create three new fields: score, model, and importance. In some cases, the score field may be a value between 0 and 1 indicating how anomalous the instance is. In some cases, an anomaly score of >0.6 are considered interesting. The model field is a unique ID that identifies the model and can be used within the system to recover when the model was trained, by whom, and on what data, for instance. The importance field may rely on a dictionary of field importance which describes the relative importance of each input variable in computing the score. These importance help address the question of how the instance is anomalous. In other words, the system may weight field importance values that have a higher importance. Thus, an anomalous value associated with a higher importance variable is weighted heavier in determining the overall threat score than an anomalous value associated with a lower importance variable. In some cases, the values are the Shapley Additive explanations (SHAP values), and in some cases, the SHAP values are only determined where the anomaly score is greater than a threshold anomaly value, such as greater than 0.4, or 0.5, or 0.6, or 0.7 for example.

The overall scoring step 314 may combine the timescale specific scores into an overall threat score. In some cases, a single Kafka Streams app joins the timescale scoring streams by key (e.g., ADS-B Target ID): BIGML.SCORE.10SEC.JSON, BIGML.SCORE.20SEC.JSON, BIGML.SCORE.30SEC.JSON, BIGML.SCORE. 1MIN, BIGML.SCORE.2MIN.JSON, BIGML.SCORE.3MIN.JSON, BIGML.SCORE.5MIN.JSON, BIGML.SCORE. 10MIN.JSON, for example.

In some examples, when a new message is published in one of the input topics, a new overall scoring message may be triggered and published to BIGML.SCORE.OVERALL.JSON. In this case, an overall score field 314 may be added, which may be the arithmetic mean of the timescale scores. In some embodiments, these messages are the output of the EDT scoring pipeline 300, and would typically be what a front end consumes, such as a user interface 316 that displays information regarding the scoring and anomalies.

### Flight Plan Tracking

In some examples, flight plan tracking produces numeric estimates of how closely the aircraft adheres to a pre-specified flight plan for each flight message Mₙ in a time sequence of messages M₀, . . . , M_{N}. The collection of estimates F, for a flight segment represented by multiple messages characterized by a standardized set of features. Model derived from some number of such feature sets using ML techniques may then be used to classify a new feature set in some way. For example, isolation forests may be used to classify a feature set, and ultimately, the flight segment from which the numeric estimates are derived, as anomalous in some way.

In some embodiments, the measure adherence to a flight plan uses a sequence of latitude-longitude pairs (lat-long pairs) p₀, . . . , pₖ defined by the departure airport, waypoints, and the arrival airport. Where lat-long pairs from a sequence of flight messages are provided, they can be compared against the straight-line segments between the flight plan waypoints.

By determining the distance between the plane at a position qₙ specified in message M_{N}, and the flight plan segment between any two waypoints pₖ₋₁ and pₖ, the deviation from the flight plan can be quantified and scored. In some cases, multiple values of the deviation along the flight plan are determined, which may be represented as a histogram and apply that as a feature vector for machine learning to build a model. However, in some cases, the values of the deviation can be calculated and used as a feature vector.

### Flight Route Propensity

In some embodiments, anomalous aircraft flight paths are classified through a classification process. In some cases, the classification process uses a Naive Bayesian classification process. The Naive Bayes classification algorithm is a probabilistic classifier that incorporates strong independence assumptions. The assumptions may not have an effect on reality and are thus considered as naive.

In some embodiments, Naive Bayesian classification is used to estimate component probabilities from flight messages. In this probabilistic approach, the system is configured to determine whether an aircraft's position represented in a message is anomalous. The position may be determined to be anomalous where the position score relative to the flight plan position is greater than a threshold score.

For example, given two events A and B, Bayes theorem expresses the probability of the posterior event B, given occurrence of the prior event A

$$Pr ( B \vert A ) = \frac{Pr ( A \vert B ) Pr ( B )}{Pr ( A )} \qquad Eq . 5.1$$

As (Eq. 5.1) is symmetric, the designation of posterior and prior events depends on interpretation of the application to (E1 5.1) in a specific situation.

According to some embodiments, the conditional probabilities in (E1 5.1) make Bayes theorem a natural basis for data models. The left side is the probability of a target event B given observed factor event A. The right side expresses the probability in terms of the conditional probability of the observed factor event for the target event B.

In some cases, Bayes theorem can be applied to classifiers as:

$$\begin{matrix}Pr ( {C}_{k} \vert x ) = \frac{Pr ( x \vert {C}_{k} ) Pr ( {C}_{k} )}{Pr ( x )} & k = 1 , … , K \\ = \frac{Pr ( x \vert {C}_{k} ) Pr ( {C}_{k} )}{{\sum }_{l = 1 , … , K} Pr ( x \vert {C}_{l} ) Pr ( {C}_{l} )} & k = 1 , … , K\end{matrix} \qquad ( Eq . 5.2 )$$

In explanatory terms, for each class k:

$$posterior = \frac{likelihood \times prior}{evidence} \qquad ( Eq . 5.3 )$$

In some examples, Naive Bayes Classifiers simplify computation of the classification probabilities in two ways. First, despite the appearance of the classes Cₖ in the denominator of (5.2), (5.1) and (5.3) show the denominator is solely determined by the evidence x.

The second simplification, is the “naive” assumption that the elements of x are independent:

$$Pr ( x \vert {C}_{k} ) = {\prod }_{i} Pr ( {x}_{i} \vert {C}_{k} )$$

As a result

$$Pr ( {C}_{k} \vert x ) ∝ {\prod }_{i} Pr ( {x}_{i} \vert {C}_{k} ) Pr ( {C}_{k} ) \qquad ( Eq . 5.4 )$$

In some cases, we may treat (5.4) as an equality in applications where we assume that the x are equally likely or when we are given x and simply want to find Pr(Ck|x) with no knowledge of Pr(x). When we also assume the classes themselves are equally likely, (5.4) reduces further to:

$$Pr ( {C}_{k} \vert x ) = {\prod }_{i} Pr ( {x}_{i} \vert {C}_{k} )$$

In some instances, using this probability approach to anomaly detection, we can find: Pr (anomalous|position)=1−Pr (not anomalous|position)

We may also determine a threshold 0<\theta<1 such that we declare position to be anomalous if Pr(anomalous|position)>θ.

Further, if we let C_{A} and C_{N} denote the “anomalous” and “not anomalous” classes, and x denote a position observation, then by Bayes theorem:

$$\begin{matrix}Pr ( {C}_{A} \vert x ) = 1 - \frac{Pr ( x \vert {C}_{N} ) Pr ( {C}_{N} )}{Pr ( x \vert {C}_{N} ) Pr ( {C}_{N} ) + Pr ( x \vert {C}_{A} ) Pr ( {C}_{A} )} \\ = \frac{Pr ( x \vert {C}_{A} ) Pr ( {C}_{A} )}{Pr ( x \vert {C}_{N} ) Pr ( {C}_{N} ) + Pr ( x \vert {C}_{A} ) Pr ( {C}_{A} )}\end{matrix} \qquad ( Eq . 5.6 )$$

We may derive the basic Naïve Bayes Classifier for the non-anomalous case directly from (5.6):

$$Pr ( {C}_{N} \vert x ) ∝ {\prod }_{i} Pr ( {x}_{i} \vert {C}_{N} ) Pr ( {C}_{N} ) \qquad ( Eq . 5.7 )$$

Here xᵢ are the components of x.

Because (5.7) includes Pr(C_{N}), technically it is one of the two models that together may comprise a two-class Naive Bayes classifier. However, the anomaly detection problem includes the case where the training data only includes not-anomalous instances. This has several implications.

For example, with no anomalous instances, we have no principled way to estimate Pr(C_{N}). Equivalently, we can't estimate Pr(C_{N} x) and Pr(C_{A} x) to inform a decision whether x is anomalous or not anomalous, i.e. in C_{A} or C_{N}. From yet another perspective, we can't directly specify a threshold value θ such that we can classify x is anomalous if Pr(C_{N}|x)>θ.

Nonetheless, so-called one-class classification is an important problem for many applications including anomaly detection. Realizing a K-class classifier as a set of K one-class classifiers is another significant application. Although we generally think of Naive Bayes classifiers for K 2, it's straightforward to define a Naive Bayes classifier for K=1

In one-class classification we only have training instances x∈X_{T} for the single class. For K=1 we may use the conceptually simple approach of defining a decision threshold as a value:

$$θ = {min}_{x ∈ {X}_{T}} ( {\prod }_{i} Pr ( {x}_{i} \vert {C}_{N} ) ) \qquad ( Eq 5.8 )$$

In some cases, for new instances x:

$$x ≡ \{ \begin{matrix}anomalous & {\prod }_{i} Pr ( {x}_{i} \vert {C}_{N} ) < θ \\ not ‐ anomalous & {\prod }_{i} Pr ( {x}_{i} \vert {C}_{N} ) \geq θ\end{matrix} \qquad ( Eq . 5.9 )$$

A simple Naive Bayes approach for anomaly detection than comes down to practical methods for computing the component probabilities Pr(xᵢ|C_{N}), which can be applied to flight messages.

Considering (5.8) and (5.9) further, a modified one-class Naive Bayes classifier may simply estimate the probability a new instance x is similar to the collection of instances X_{T} used to build the classifier instance. As a first step we may use a memory and operation efficient method for computing the component probabilities Pr(xᵢ C_{N}) from a training dataset X_{T} that may consist solely of instances x drawn from the not-anomalous class C_{N}. We may frame a practical method based on ideas and empirical probability estimates.

As raw data, let M₀, . . . , M_{N} denote a collection of messages Mₙ associated with all aircraft flying over a region R of 2-D space. These messages are from one or more aircraft traversing R for some period of time. For a practical estimator we can let the component x; in a flight path observation x be sectors defined by ranges of longitude and latitude an aircraft traverses as indicated by (lon, lat) pairs in the Mₙ. In what follows, an observation x for a single flight is the collection of sectors xᵢ in region R traversed by that single flight from the sequence of contiguous messages for that flight among the total collection of messages Mₙ for all flights in R.

We can let R denote a collection of non-overlapping sectors for a geographic region R. We may assume a region of sectors is defined for each airport and that multiple regions are defined for the geographic area of interest exclusive of airports. One type of flight anomaly detector could be realized as multiple one-class Naive Bayes classifiers, one for each region. Simply put, for a region R we can estimate the probability Pr(xᵢ|C_{N}) for sectors xᵢ∈R, as:

$$Pr ( {x}_{i} \vert ℛ , {C}_{N} ) ≅ \frac{\# ( {M}_{n} ∈ {x}_{i} )}{\# ( {M}_{n} ∈ ℛ )} , {x}_{i} ∈ ℛ \qquad ( Eq . 5.1 )$$

over some interval of time τ. Mₙ∈xᵢ and Mₙ∈R are shorthand indicating that the (lon, lat) pair in Mₙ is a point in sector xᵢ and in the sectors of the collection R for region R. #(Mₙ∈xᵢ) and #(Mₙ∈R) denote the message counts in xᵢ and R, respectively.

With the non-zero Pr(xᵢ|C_{N}) computed as in (5.10) for a region, in principle we can use (5.8) to compute the threshold θ for the region. We could then use (5.9) to classify a sequence of new messages Mⱼ for a single flight as indicative of an anomalous flight path. For this application we compute the individual Pr(xᵢ|C_{N}) of an flight path observation x and build anomaly detectors from multiple such observations to classify new flight path observations as normal or anomalous.

The definition (5.10) of Pr(xᵢ|C_{N}) implies accumulating messages Mₙ over a time interval τ, or as sets of N messages. In turn, either can be implement on a block basis or as the effective memory of a fading memory accumulator process. The former requires O(NL|R|) storage while the latter only requires O(L|R|) storage, where L is the number of regions under consideration and |R| is the number of sectors defined for a region. Developing block solutions may primarily require working out algorithmic details of actually storing sector identifiers for the blocks of N messages. For a fading memory approach, we may relate effective memory to the parameters of the fading memory process. Here we can do that for a simple time-based exponentially weighted moving average process.

For some embodiments, we can assume we have a sequence of samples x(t₀=k₀T), x(t₁=k₁T), . . . , x(tₙ=kₙT). Using our count function notation, for a sequence like this we express Exponentially Weighted Moving Average (EWMA) windowing as:

$$\begin{matrix}\# ( {t}_{n} ) = β {\sum }_{i = 0}^{k} {e}^{- λ ( {t}_{n} - {t}_{i} )} x ( {t}_{i} ) \\ = β x ( {t}_{n} ) + {\sum }_{i = 0}^{n - 1} {e}^{- λ ( {t}_{n} - {t}_{n - 1} + {t}_{n - 1} - {t}_{i} )} β x ( {t}_{i} ) \\ = β x ( {t}_{n} ) + {e}^{- λ ( {T}_{n} - {t}_{n - 1} )} {\sum }_{i = 0}^{n - 1} {e}^{- λ ( {t}_{n - 1} - {t}_{i} )} β x ( {t}_{i} ) \\ = β x ( {t}_{n} ) + {e}^{- λ ( {t}_{n} - {t}_{n - 1} )} \# ( {t}_{n - 1} ) \\ = β x ( {t}_{n} ) + {e}^{- λ T ( {k}_{n} - {k}_{n - 1} )} \# ( {t}_{n - 1} )\end{matrix} \qquad ( Eq . 5.11 )$$

And therefore, as a discrete time expression as:

$$\# ( {k}_{n} ) = β x ( {k}_{n} ) + {α}^{{k}_{n} {k}_{n - 1}} \# ( {k}_{n - 1} ) \qquad ( Eq . 5.12 )$$

In some cases, for this time-based EMWA window, the equivalent sector and region counts are computed as

$$\# ( {M}_{n} ∈ {x}_{i} ; {k}_{n} ) = β {x}_{i} ( {k}_{n} ) + {α}^{{k}_{n} - {k}_{n 1}} \# ( {M}_{n} ∈ {x}_{i} ; {k}_{n - 1} ) \qquad ( Eq . 5.13 )$$

$$\# ( {M}_{n} ∈ R ; {k}_{n} ) = β R ( {k}_{n} ) + {α}^{{k}_{n} - {k}_{n 1}} \# ( {M}_{n} ∈ R ; {k}_{n - 1} ) \qquad ( Eq . 5.14 )$$

where kₙ is the index for the occurrence time tₙ=kₙT of Mₙ. To avoid introducing new notation, we use xᵢ(kₙ) and R(kₙ) to denote 0-1 functions indicating that Mₙ∈xᵢ and Mₙ∈R, respectively.

Several considerations determine α and β. If we assume kₙ−kₙ₋₁=1 and x(k)=1 for all k in the discrete time expression (5.12),

$$\begin{matrix}\# ( {M}_{n} ∈ {x}_{i} ; {k}_{n} ) = \frac{β ( 1 - {α}^{n} )}{1 - α} \\ and \\ {lim}_{n \to ∞} \# ( {M}_{n} ∈ {x}_{i} ; {k}_{n} ) = \frac{β}{1 - α}\end{matrix}$$

If we would like the last N samples to constitute a fraction 0<w<1 of the total in the EWMA window:

$$w = \frac{\# ( {M}_{n} ∈ {x}_{i} ; {k}_{n} )}{{lim}_{n \to ∞} \# ( {M}_{n} ∈ {x}_{i} ; {k}_{n} )} = 1 - {α}^{N}$$

Finally,

$$α = {e}^{- λ T} = {e}^{ln ( 1 - w ) / N} \qquad ( Eq . 5.15 )$$

Having arrived at (5.15), we may set β=g(1−α) for any arbitrary gain g.

The definition (5.10) of the estimated sector probabilities in a region focuses attention on the the counts for messages that reference locations within the collection R of sectors covering a region R. If we re-express (5.13) and (5.14) to make the linearity explicit:

$$\# ( {M}_{n} ∈ {x}_{i} ; {k}_{n} ) = {\sum }_{l ∈ 0 , … , n} {α}^{{k}_{n} - 1} β {x}_{i} ( {k}_{n} ) \qquad ( Eq . 5.16 )$$

$$\# ( {M}_{n} ∈ ℛ ; {k}_{n} ) = {\sum }_{l ∈ 0 , … , n} {α}^{{k}_{n} - 1} β ℛ ( {k}_{n} ) \qquad ( Eq . 5.17 )$$

and the expanded property:

$$\# ( {M}_{n} ∈ ℛ ; {k}_{n} ) = {\sum }_{{x}_{i} ∈ ℛ} \# ( {M}_{n} ∈ {x}_{i} ; {k}_{n} )$$

From this, we can see that empirical probabilities sequences sum property:

$${\sum }_{{x}_{i} ∈ ℛ} Pr ( {x}_{i} \vert ℛ , {C}_{N} ; {k}_{n} ) ≅ {\sum }_{{x}_{i} ∈ ℛ} \frac{\# ( {M}_{n} ∈ {x}_{i} ; {k}_{n} )}{\# ( {M}_{n} ∈ ℛ ; {k}_{n} )} = 1$$

It follows that we can specify α as expressed in (5.15).

Considering β next, from Eqns. (5.16) and (5.17) we see that the empirical probabilities don't depend on β:

$$Pr ( {x}_{i} \vert ℛ , {C}_{N} ; {k}_{n} ) ≅ \frac{{\sum }_{l ∈ 0 , … , n} {α}^{k - 1} β {x}_{i} ( k )}{{\sum }_{l ∈ 0 , … , n} {α}^{k - 1} β ℛ ( {k}_{n} )} = \frac{{\sum }_{l ∈ 0 , … , n} {α}^{k - 1} {x}_{i} ( {k}_{n} )}{{\sum }_{l ∈ 0 , … , n} {α}^{k - 1} ℛ ( {k}_{n} )}$$

As expected, we can arbitrarily select β to facilitate other objectives. In particular, in some cases, we can let β=g(1−α).

As discussed above, the single-class Naive Bayes' classifier (5.9) may require a computation of the estimated probability that a flight traverses the combination of sectors xᵢ in some region R it does based on some set of previous flights. For the conventional classifier we can compute that estimated probability as the product of the individual sector probabilities and decide whether the flight route is anomalous or not based just on that single product. Alternatively, we can accumulate the set of individual message probabilities in (5.9) and compute multiple attributes of the distribution of those individual probabilities as features for a machine learning model built from the observations for multiple flights. Once we do anomaly detection based on attributes of the distribution of flight measures, we can use message measures, which we refer to here loosely as propensity measures other than just simple probability estimates. We describe three propensity measures we have investigated so far.

According to some embodiments, the simplest propensity measure is just the estimated single sector probabilities:

$${e}_{P ; i} ( k ) ≡ Pr ( {x}_{i} \vert ℛ , {C}_{N} ; k ) \qquad ( Eq . 5.18 )$$

An anomaly detector could implicitly combine these propensities into required flight path probabilities to do anomaly detection exactly in the spirit of (5.8) and (5.9). In addition to being composable, the single sector probabilities can be used directly to produce calibrated anomaly classifiers.

The single sector probabilities also lend themselves to straightforward multi-region solutions. Suppose a flight traverses multiple regions Rⱼ. We can trivially extend the definition of the single sector probability as the joint probability:

$${e}_{P ; ij} ( k ) ≡ Pr ( {x}_{i} \vert {ℛ}_{j} , {C}_{N} ; k ) Pr ( {ℛ}_{j} \vert {C}_{N} ; k ) = Pr ( {x}_{i} , {ℛ}_{j} \vert {C}_{N} ; k ) \qquad ( Eq . 5.19 )$$

The Naive Bayes estimator and the alternative anomaly detection strategy using attributes of the single sector propensity measure distribution for the flight path trivially extend to this joint probability.

According to some embodiments, the propensity measure e_{P;i}(k) preserves composability to directly enable path anomaly detection. The basic measure conceptually enables intra-region determinations that a flight route is likely not anomalous but not an inter-region determination. The extended measure may enable inter-region determinations. Unfortunately, the wide dynamic range of this measure, especially when flights traverse multiple regions, can in practice can be a limitation when building useful models for anomaly detection. A propensity measure that implicitly reduces the intra-region dynamic range may be defined as:

$${e}_{N ; i} ( k ) ≡ \frac{Pr ( {x}_{i} \vert ℛ , {C}_{N} ; k )}{{max}_{{x}_{j} ∈ ℛ} Pr ( {x}_{j} \vert ℛ , {C}_{N} ; k )} ≅ \frac{\# ( {M}_{n} ∈ {x}_{i} ; k )}{{max}_{{x}_{j} ∈ ℛ} \# ( {M}_{n} ∈ {x}_{j} ; k )} \qquad ( Eq . 5.2 )$$

where e_{N;i} (k) distributes the sector propensity values in a single region more widely over the range [0, 1]. However, it may implicitly align all regions. As a result, this propensity measure may not differentiate between low probability regions and high probability regions. However, differentiation may be possible through region-scaled propensity.

The approach of accumulating individual message propensity measures and computing attributes of the distribution of those distributions allows us to consider message propensity measures other than simple probability estimates. This can be viewed as a form of implicit feature engineering for machine learning. As a first example we may combine the single sector propensity and normalized propensity.

To develop a combined propensity measure it's helpful to first introduce some more probability estimates:

$$Pr ( {x}_{i} , ℛ \vert {C}_{N} ; k ) ≅ \{ \begin{matrix}\frac{\# ( {M}_{n} ∈ {x}_{i} ; k )}{\# ( {M}_{n} ; k )} & {x}_{i} ∈ ℛ \\ 0 & {x}_{i} ∉ ℛ\end{matrix}$$

$$Pr ( ℛ \vert {C}_{N} ; k ) ≅ \frac{\# ( {M}_{n} ∈ ℛ ; k )}{\# ( {M}_{n} ; k )}$$

These definitions are consistent with Eq. 5.10 in that

$$\begin{matrix}Pr ( {x}_{i} \vert ℛ , {C}_{N} ; k ) = \frac{Pr ( {x}_{i} , ℛ \vert {C}_{N} ; k )}{Pr ( ℛ \vert {C}_{N} ; k )} \\ ≅ \frac{\# ( {M}_{n} ∈ {x}_{i} ; k ) / \# ( {M}_{n} ; k )}{\# ( {M}_{n} ∈ ℛ ; k ) / \# ( {M}_{n} ; k )} \\ = \frac{\# ( {M}_{n} ∈ {x}_{i} ; k )}{\# ( {M}_{n} ∈ ℛ ; k )} , {x}_{i} ∈ ℛ\end{matrix} \qquad ( Eq . 5.21 )$$

It is also notable that using these definitions, Eq. 5.20 can be expressed as

$${e}_{N ; i} ( k ) ≡ \frac{Pr ( {x}_{i} , ℛ \vert {C}_{N} ; k )}{{max}_{{x}_{j} ∈ ℛ} Pr ( {x}_{j} , ℛ \vert {C}_{N} ; k )} \qquad ( Eq . 5.22 )$$

For one region-scaled propensity measure we can weight Eq. 5.20 estimated from counts by the region count:

$$\begin{matrix}{e}_{L ; i} ( k ) ≅ {e}_{N ; i} ( k ) \# ( {M}_{n} ∈ ℛ ; k ) ξ \\ ≅ \frac{\# ( {M}_{n} ∈ {x}_{i} ; k )}{{max}_{{x}_{j} ∈ ℛ} \# ( {M}_{n} ∈ {x}_{j} ; k )} \frac{\# ( {M}_{n} ; k )}{\# ( {M}_{n} ; k )} \# ( {M}_{n} ; k ) ξ\end{matrix}$$

where ξ is an arbitrary constant. Defined in terms of probabilities using (Eq. 5.21), we have

$$\begin{matrix}{e}_{L ; i} ( k ) ≡ \frac{Pr ( {x}_{i} \vert ℛ , {C}_{N} ; k ) Pr ( ℛ \vert {C}_{N} ; k )}{{max}_{{x}_{j} ∈ ℛ} Pr ( {x}_{j} \vert ℛ , {C}_{N} ; k )} \# ( {M}_{n} ; k ) ξ \\ ≡ \frac{Pr ( {x}_{i} , ℛ \vert {C}_{N} ; k )}{{max}_{{x}_{j} ∈ ℛ} Pr ( {x}_{j} \vert ℛ , {C}_{N} ; k )} \# ( {M}_{n} ; k ) ξ\end{matrix} \qquad ( Eq . 5.23 )$$

For windowed data, #(Mₙ; k) approaches a value that varies slowly with k (time). As a result,

$${e}_{L ; i} ( k ) ∝ \frac{Pr ( {x}_{i} , ℛ \vert {C}_{N} ; k )}{{max}_{{x}_{j} ∈ ℛ} Pr ( {x}_{j} \vert ℛ , {C}_{N} ; k )} \qquad ( Eq . 5.24 )$$

We see this propensity measure is the extended single sector propensity measure (E1. 5.19) normalized by the maximum single sector propensity for the region. Choosing ξ judiciously limits the effective dynamic range e_{L;i}(k). In particular, (Eq. 5.23) shows that e_{N;i}(k)≥e_{L;i}(k) if we choose ξ≤1/#(Mₙ; k).

To clarify this approach to region scaling, we can re-express this as:

$$\begin{matrix}{e}_{L ; i} ( k ) ∝ \frac{Pr ( {x}_{i} , ℛ \vert {C}_{N} ; k )}{{max}_{{x}_{j} ∈ {ℛ}_{i} , {ℛ}_{j}} Pr ( {x}_{j} , {ℛ}_{i} \vert {C}_{N} ; k )} \frac{{max}_{{x}_{j} ∈ {ℛ}_{i} , {ℛ}_{j}} Pr ( {x}_{j} , {ℛ}_{i} \vert {C}_{N} ; k )}{{max}_{{x}_{j} ∈ ℛ} Pr ( {x}_{j} \vert ℛ , {C}_{N} ; k )} \\ ∝ {e}_{G ; i} ( k ) \frac{{max}_{{x}_{j} ∈ {ℛ}_{i} , {ℛ}_{j}} Pr ( {x}_{j} , {ℛ}_{i} \vert {C}_{N} ; k )}{{max}_{{x}_{j} ∈ ℛ} Pr ( {x}_{j} \vert ℛ , {C}_{N} ; k )}\end{matrix}$$

Here e_{G;i}(k) is a global extension of the normalized propensity (Eq. 5.22), where the sector probability is normalized by the greatest global sector probability rather than the greatest regional probability. We observe that the factor

$$\frac{{max}_{{x}_{j} ∈ {ℛ}_{i} , {ℛ}_{j}} Pr ( {x}_{j} , {ℛ}_{i} \vert {C}_{N} ; k )}{{max}_{{x}_{j} ∈ ℛ} Pr ( {x}_{j} \vert ℛ , {C}_{N} ; k )} \geq 1$$

As a result, e_{L;i}(k)≥e_{G;i}(k) if we choose ξ≥1/#(Mₙ; k). Combining this with the relationship between e_{N;i}(k) and e_{L;i}(k) above,

$${e}_{N ; i} ( k ) \geq {e}_{L ; i} ( k ) \geq {e}_{G ; i} ( k )$$

when ξ=1/#(Mₙ; k).

### Alignment Across Regions

All three measures Eqns. (5.18), (5.20), and (5.23) may inherently or can be scaled to take values over the range [0, 1]. While Eqns. (5.18) and (5.20) maintain proportionately of sector propensities within a region, and therefore support intra-region sector comparisons, neither inherently may enable inter-region sector comparisons. One could use a separate regional propensity measure to derive features that enable inter-region sector comparisons. Alternatively, in some cases, one could use the joint probability (Eq. 5.19) or the global extension eG;i(k) defined in (Eq. 5.25) as a single propensity measure that allows both intra-region and inter-region sector comparisons. The region-scaled propensity (Eq. 5.24) seeks to combine sector propensity and region propensity in a single measure to facilitate inter-region propensity comparisons.

Another issue may come into play when comparing propensities between regions. The basic measures Eqns. (5.18), (5.20), and (5.23) are aligned at 0. For some applications it may be preferable to align regions at some ζ>0 when accumulating a set of propensities for messages from a flight segment that crosses two or more regions. We may do this by extending (Eq. 5.23) as

$${e}_{L ; i} ( k ) ≡ [ \frac{( Pr ( {x}_{i} \vert ℛ , {C}_{N} ; k ) - ζ ) Pr ( ℛ \vert {C}_{N} ; k )}{{max}_{{x}_{j} ∈ ℛ} Pr ( {x}_{j} \vert ℛ , {C}_{N} ; k )} + ζ ] \# ( {M}_{n} ; k ) ξ \qquad ( Eq . 5.25 )$$

One choice for alignment value is the value such that all sectors have equal propensity before scaling, ζ=1/100. We accomplish this computationally for the region-scaled propensity as:

$${e}_{L ; i}^{′} ( k ) ≅ [ \frac{( \# ( {M}_{n} ∈ {x}_{i} ; k ) - \# ( {M}_{n} ∈ ℛ ; k ) / 100 )}{{max}_{{x}_{j} ∈ ℛ} \# ( {M}_{n} ∈ {x}_{j} ; k )} \frac{\# ( {M}_{n} ∈ ℛ ; k )}{\# ( {M}_{n} ; k )} + \frac{1}{100} ] \# ( {M}_{n} ; k ) ξ$$

Note that this offset propensity can be scaled such that e′_{L;i}(k)∈[0, 1].

### Measure Smoothing

According to some embodiments, when we estimate propensity measures for a sector such as Eqns. (5.18), (5.20), and (5.23) from message counts, we may consider if we have accumulated enough counts in a sector xᵢ and its enclosing region R for the estimate to be useful. Expressions for how these estimates converge to the theoretical values of these measures may not be of much practical use given the expected wide variation in sector and region counts. As an alternative, we can use Laplace (additive) smoothing. In some cases, we prefer an unbiased version of Laplace smoothing that's compatible with recursive windowing.

Laplace smoothing is commonly used with categorical data and assumes a prior uniform distribution of category counts between the possible categories. Here we may assume a uniform prior distribution of messages over the sectors in a region. We extend the conventional Laplace smoother by using a pseudocount α^{k} of that decreases with time. The Laplace smoother for the single sector propensity becomes

$${\hat{e}}_{P ; i} ( k ) ≅ \frac{\# ( {M}_{n} ∈ {x}_{i} ; k ) + {α}^{k}}{\# ( {M}_{n} ∈ ℛ ; {k}_{n} ) + 100 {α}^{k}} \qquad ( Eq . 5.26 )$$

Where once again we may assume each region R has 100 sectors xᵢ.

Similarly, the Laplace smoother for the normalized sector propensity is:

$${\hat{e}}_{N ; i} ( k ) ≅ \frac{\# ( {M}_{n} ∈ {x}_{i} ; k ) + {α}^{k}}{{max}_{{x}_{j} ∈ ℛ} \# ( {M}_{n} ∈ {x}_{j} ; k ) + {α}^{k}} \qquad ( Eq . 5.27 )$$

We may only apply Laplace smoothing to the normalized propensity in the (aligned) region scaled propensity measure:

$${\hat{e}}_{L ; i}^{′} ( k ) ≅ [ \frac{\begin{matrix}( \# ( {M}_{n} ∈ {x}_{i} ; k ) - \\ \# ( {M}_{n} ∈ ℛ ; k ) / 100 + {α}^{k} )\end{matrix}}{{max}_{{x}_{j} ∈ ℛ} \# ( {M}_{n} ∈ {x}_{j} ; k ) + {α}^{k}} \frac{\# ( {M}_{n} ∈ ℛ ; k )}{\# ( {M}_{n} ; k )} + \frac{1}{100} ] \hat{ξ} \qquad ( Eq . 5.28 )$$

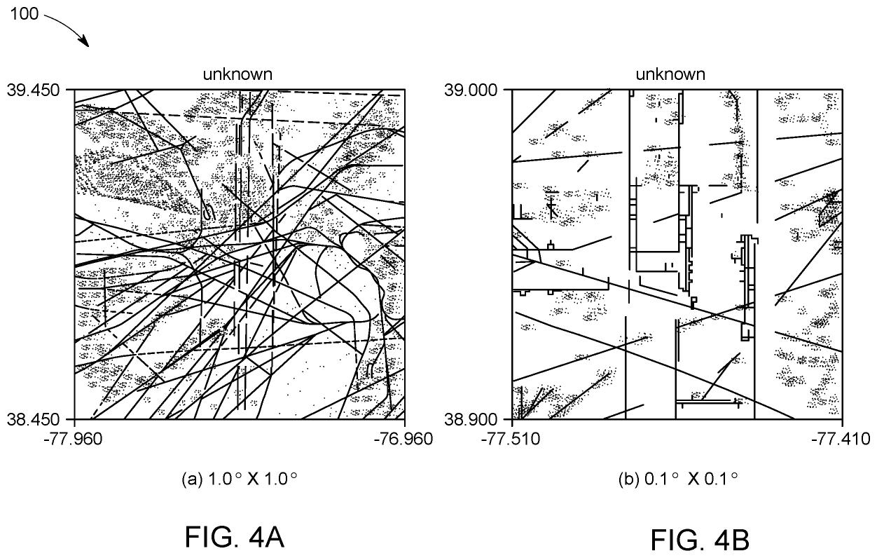

The normalized propensity can be visualized in a heat map. For example, FIGS. 4A and 4B present heatmaps of the normalized propensity measure aligned across regions and with smoothing for 1-degree and 0.1-degree areas around Dulles airport. Similar heatmaps may be created for nearly any airport and creating heatmaps for the busy airports, such as those airports with Class B airspace and/or Class C airspace.

### Model Training

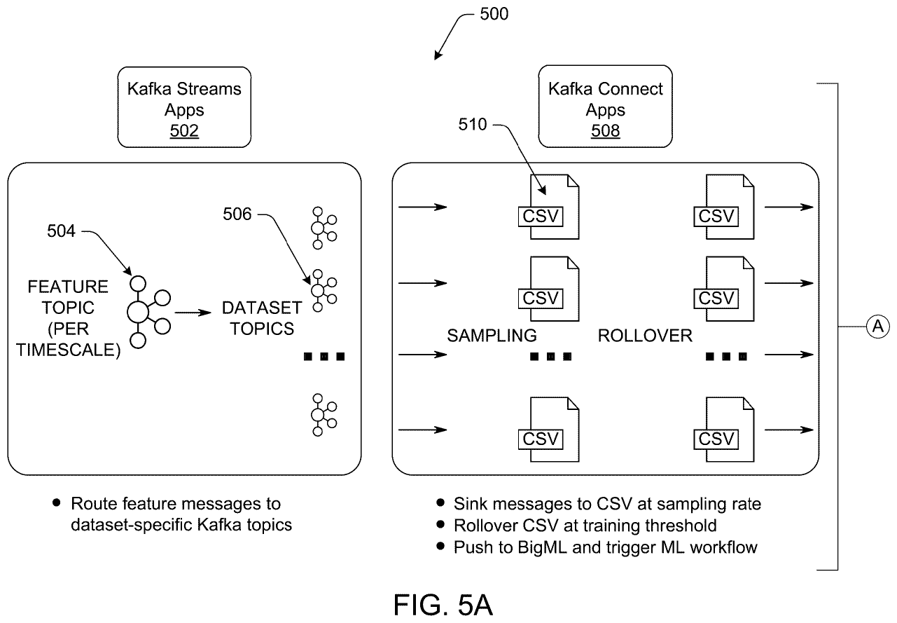

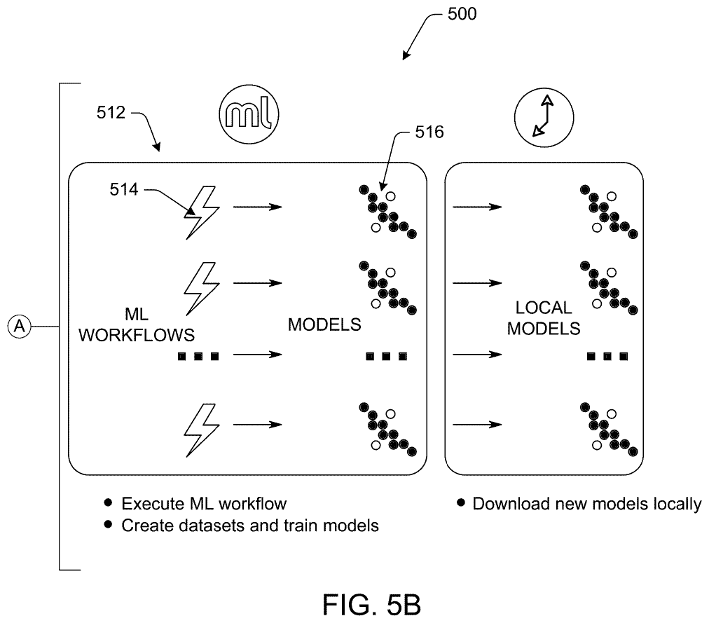

With reference to FIGS. 5A and 5B, model training may be performed through a continuous retraining pipeline 500. In some cases, models are trained for each timescale (e.g., 8 unique timescales), aircraft type (e.g., 11 unique aircraft types), and engine type (e.g., 11 unique engine types), which in some cases, results in a total of 968 possible models. In some cases, fewer than the total possible models are trained since not all combinations of aircraft and engine type are currently attested in the FAA registry table.

According to some embodiments, a number of Kafka Streams Apps 502 are deployed to route dataset messages. In some cases, there may be five, six, eight, ten, twelve or more Kafka Streams Apps and may correlate with the number of unique timescales. According to some embodiments, each Kafka Stream App consumes a particular timescale feature topic (e.g., BIGML.FEATURE.2MIN.JSON) 504 and routes messages based on aircraft and engine type to specific dataset topics 506. For example, a message for aircraft type 5 and engine type 5 may be routed to topic BIGML.DATASET.2MIN.5-5.JSON.

In some embodiments, custom Kafka Connect Apps 508 are implemented as CSV data sinks 510 and may be deployed for each possible dataset topic (such as, for example, BIGML.DATASET.2MIN.5-5.JSON). The Kafka Connect Apps may dump messages to a CSV file 510 at a specified sampling rate. When a specified rollover threshold (number of instances) is reached, the CSV may be rolled over, compressed, and/or uploaded to the BigML Virtual Private Cloud (VPC). Configuration parameters may be tuned so models do not train more frequently than once per day, although most topics accumulate messages at a much slower rate than that.

In some examples, once a CSV file 510 is imported into BigML 512 as a new data source 514, a server-side script, (which in some examples may be written in the BigML WhizzML scripting language), may be executed to train a new model 516. The script may ignore some or all of the ID fields, and may train an anomaly detector. In some cases, the anomaly detector is trained using the isolation forest algorithm, and in some cases, may use 64 trees per forest.

In some cases, a cronjob, such as on ceres, may be used to activate models into the real-time scoring pipeline 300. Occasionally, a script may be run that compares the latest model in the BigML VPC with the model currently in local storage for each timescale, aircraft type, and engine type. If a newer model is available, it is downloaded. The script may be run on a set schedule, such as once every ten minutes, every thirty minutes, every sixty minutes, every two hours, four hours, or some other schedule given the likelihood of updated models being available.

In-memory models used by the scoring pipeline 300 may expire after a predetermined period, such as, for example, one hour, there may be a short delay, (e.g., two-hour delay), between training a new model and activating it (one hour to download locally plus one hour to load into memory) and in many cases, the short delay may be less than two hours.

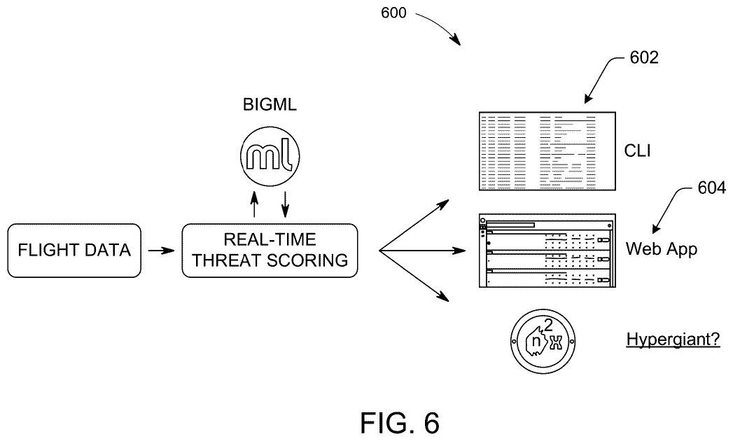

With reference to FIG. 6 a front-end system is illustrated for accessing the EDT system 100 and the scoring pipeline 300. According to some embodiments, a front end 600 is provided that allows an end user to access the EDT system. In some cases, the EDT system may be provided as a service.

As described, the scoring pipeline 300 may annotate real-time flight data with ML-based threat scores, and may further publish the result to a Kafka topic to enable easy integration with other N2X systems.

In some embodiments, the EDT system 100 may provide two simple frontends-a CLI frontend and a web app frontend-which may be used for viewing current top-scoring threats; however, in some cases, the scoring pipeline 300 is completely frontend agnostic.

According to some embodiments, a simple command-line frontend 600 may be provided, which in some cases may be implemented in Python. The only dependency may be to the kafka-python library.

The CLI front-end 602 shows a display, which may be similar to the UNIX top command, showing the top current threats. In some cases, only the most recent score for each ADS-B target ID is shown, and scores may expire from the list according to a predetermined interval, such as 1 hour. The lists may be ordered by score in descending order, and the scores may be color-coded by threat level. In some cases, the CLI front end 602 displays a list of ADS-B target IDs, a timestamp for the score, a manufacturer and/or model of the target ID, and a threat score. The color coding by threat level may be any suitable color coding scheme, but in some cases, where a threat score is above a first threshold, the line item associated with the threat is colored in a first color. Where a threat score is below the first threshold and above a second threshold, the threat may be colored in a second color.

In some cases, a web front end 604 may alternatively or additionally be provided. In some embodiments, the web app front end 604 may be implemented in Python and may provide data indicative of a live Threat Feed and/or a Top Threat view. In some cases, the feed may be paused, resumed, and may be filtered by threat level. According to some embodiments, the ADS-B target IDs may be hyperlinked to real-time flight data and visualization of the flight data, including flight path, breadcrumb trails showing flight path history, altitude information, speed information, registration tail numbers, owner details, among other aircraft data. In some cases, the real-time flight data is provided by a third party, such as FlightAware. In some embodiments, the threat level thresholds are configurable.

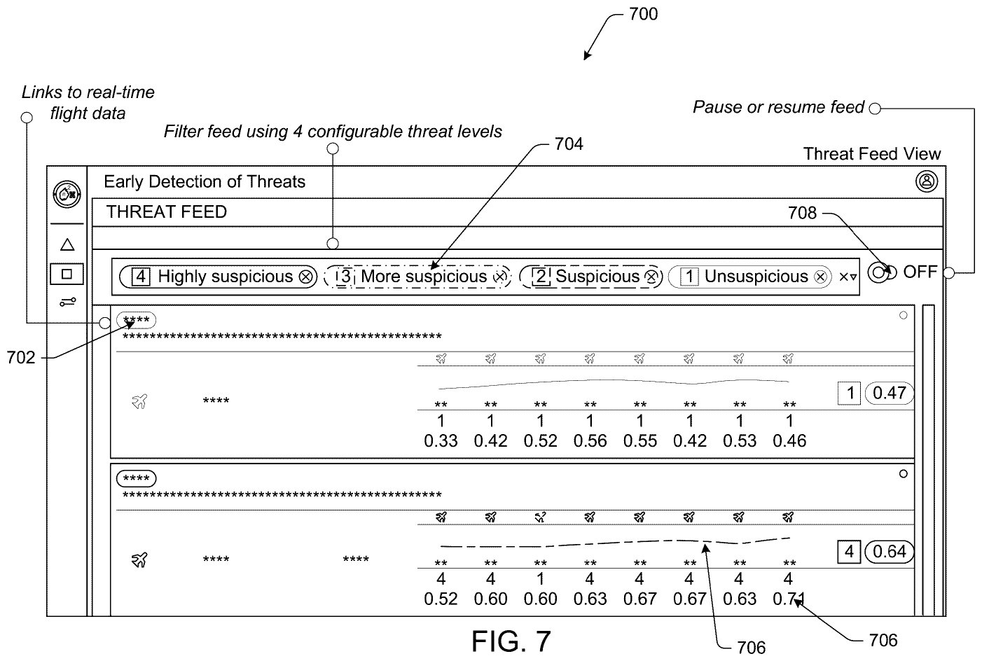

FIG. 7 illustrates a front end showing a threat feed 700. As used herein, the term “front end” is used to refer to a user interface. In other words, a screen that a user can view is considered a front end and the machine learning processes described herein convert the raw input data into a usable format that is easily digestible by a human in order to understand the most important information in a timely manner. In some examples, the aircraft with the highest threat score is displayed at the to of the threat feed 700. The ADS-B target ID may be hyperlinked 702 to a third-party data provider may include additional information about the aircraft, such as real-time flight data. A threat level filter 704 may be provided to allow a user to focus on a specific threat level or levels in the user interface.

A time-based ticker 706 may provide historical threat scores for the ADS-B target ID showing the computed threat score over time. The time-based ticker 706 may show the computed threat score, a graph of the threat score over time, and the threat level over time. The time-based ticker 706 may be paused 708 by actuating a control displayed on the threat feed 700. A user may interact with the threat feed 700 through any suitable human to computer interface, which may include a mouse, a touch screen display, a stylus, a track ball, voice command, gesture-based controls, eye tracking controls, or any other suitable interface that allows a user to input commands to a computer.

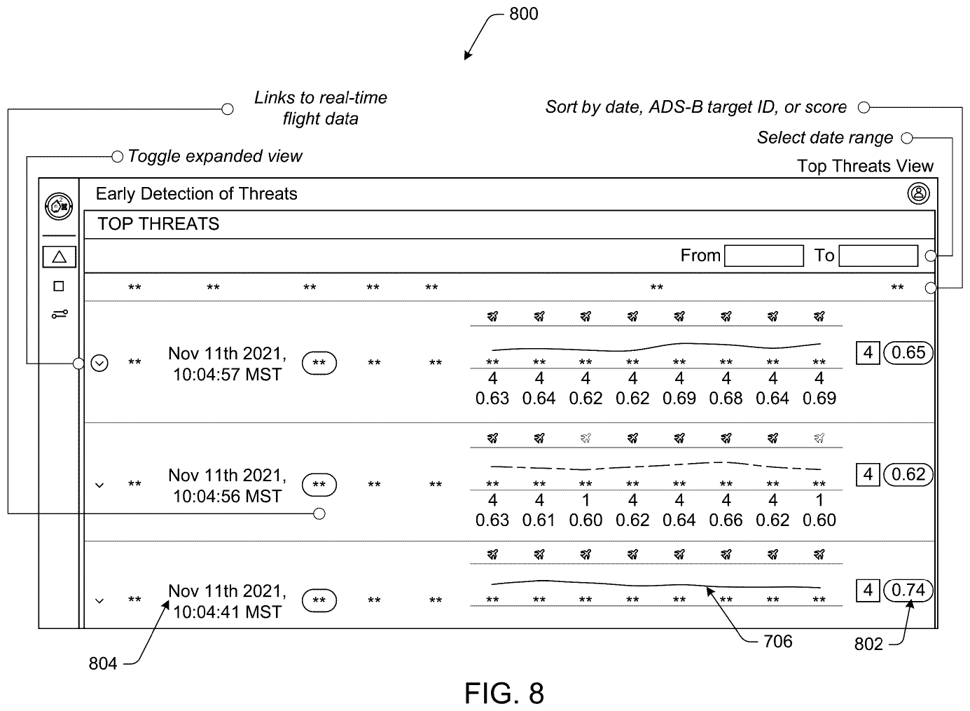

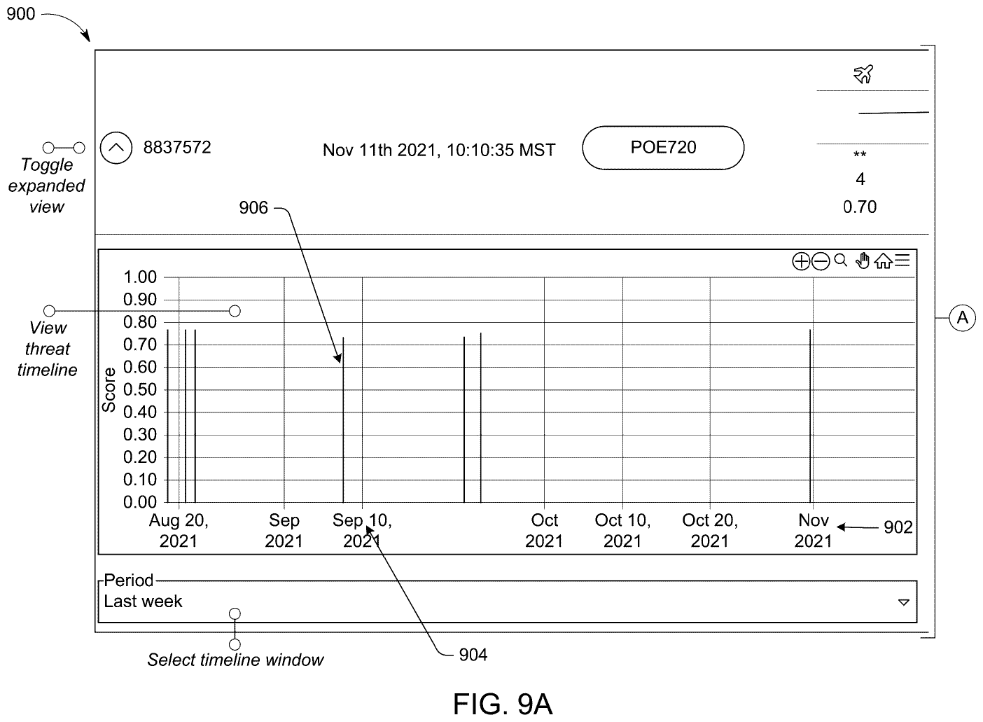

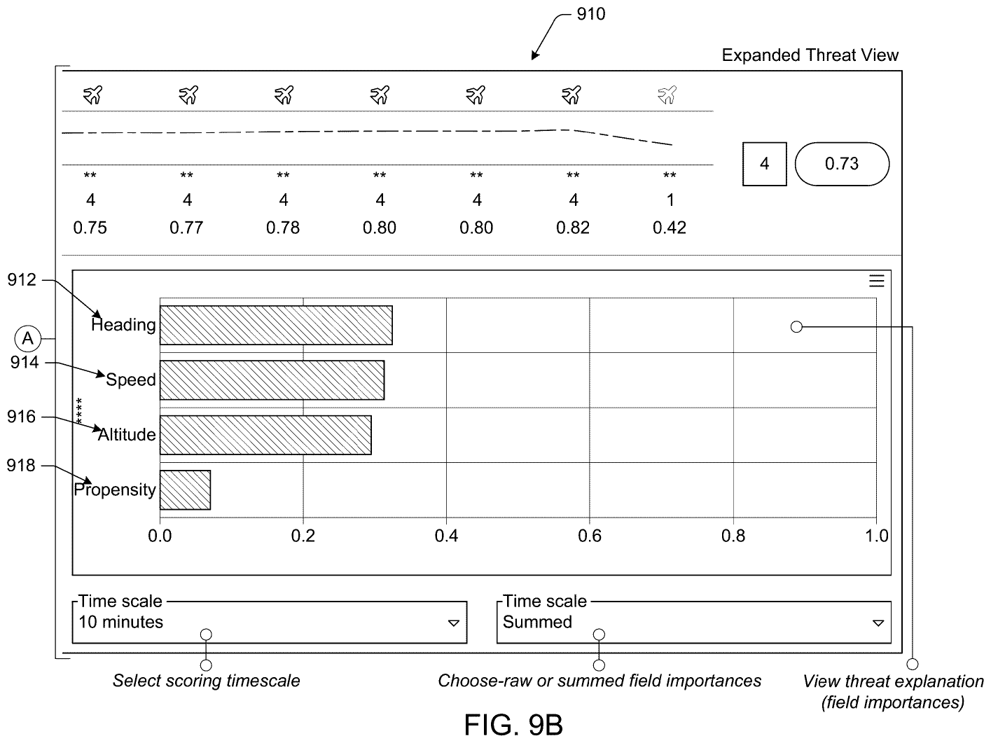

FIG. 8 illustrates a Top Threats view 800 in which the ADS-B targets may be sorted by threat level 802, which may be based on score, the most recent first, a combination of time and score, or some other threat metric. In some cases, the Top Threats view 800 is configurable and an expanded view of the particular scoring event may display a timeline of anomalies for that ADS-B target ID, and may further display field importances indicating in what way the flight was found to be anomalous. In some cases, the Top Threat view 800 may be configurable to only show flights that score above a threshold threat score, such as a threat score≥0.60 in some cases. The Top Threat view 800 may further be configured to provide additional data, such as the ADS-B target ID of the aircraft posing the largest immediate threat, a tine-based ticker 706 showing how the threat score has changed over time, a time stamp 804 associated with the latest threat score, among other information. FIGS. 9A and 9B illustrate an expanded view 900 of a particular scoring event.

According to some embodiments, a timeline 902 of anomalies for a particular ADS-B target ID are displayed, which may include a date and/or time of the threat score being above a threshold value 904, a graph representing the threat score 906. An expanded view 910 (FIG. 9B) may show additional details responsible for the threat score which may include aircraft flight details, such as heading 912, speed 914, altitude 916, location, propensity 918, among others. For example, if an aircraft has exceeded a prescribed speed, then the speed may be responsible for a significant portion of the total threat score. With additional contributing factors, such as a heading that deviates from the filed flight plan, this factor will be factored into the threat score and will raise the threat score.

As with any embodiment herein, the processes, systems, components, machine learning, and outputs may be performed in hardware, software, or a combination of hardware and software. In some cases, the systems rely on specialized computing devices that provide ADS-B data, such as an ADS-B transponder that may be associated with individual aircraft and the ADS-B signals may be relayed via ground-based, air-based, and/or space-based relay stations to an ADS-B receiver.

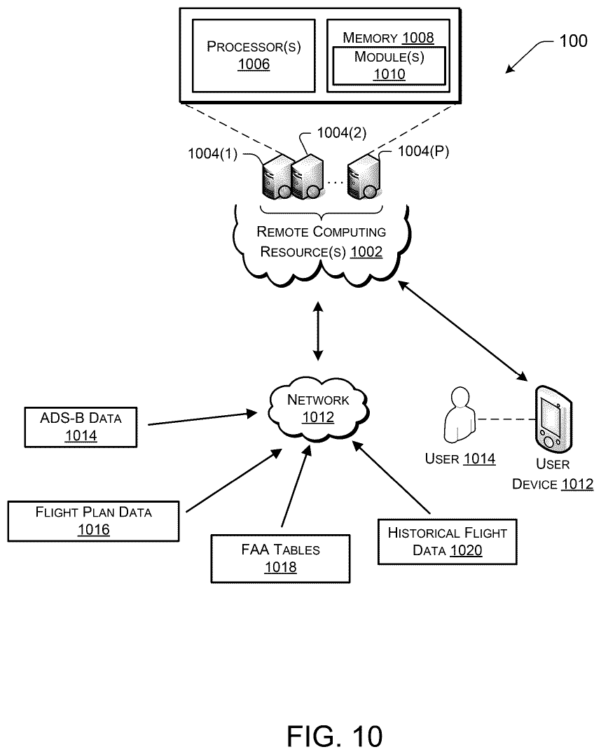

FIG. 10 illustrates an EDT architecture 100 in accordance with some embodiments. According to some embodiments, remote computing resources 1002 may comprise any suitable architecture, such as one or more servers, a distributed computing environment, a cloud-based service, and in some cases may include servers 1004(1), 1004(2) . . . 1004(P). The remote computing resources 1002 may include one or more processors 1006 coupled to memory 1008. The memory may store one or more modules 1010 that comprise instructions that can be executed by the one or more processors to carry out the embodiments, including the methods and processes described herein.

The remote computing resources 1002 may be communicatively coupled to a network 1012, such as the internet, through any suitable connection, including a wired or wireless connection. The remote computing resources 1002 may receive data input from a number of sources. For example, the remote computing resources 1002 may receive ADS-B 1014 data that may include flight information for a number of aircraft. The ADS-B data may include, without limitation, aircraft registration identifiers, aircraft manufacturer, aircraft model, engine type, altitude, speed, current location, direction, departure location, destination location, attitude, among others. In some cases, the ADS-B data may include data on thousand, tens of thousands, and even hundreds of thousands of aircraft flights. The remote computing resources 1002 may further receive flight plan data 1016 that may include data associated with a filed flight plan by an aircraft. The flight plan data 1016 may include an airport of departure, departure procedures, way points, time of departure, estimated time of arrival, time en route between way points, destination airport, arrival procedures, estimated time of arrival, among other information.

The remote computing resources 1002 may further receive data including FAA flight tables 1018. This information may correlate an aircraft registration number with a manufacturer and model of aircraft, year of manufacture, status of required inspections, among other things.

The remote computing resources 1002 may further receive historical flight data 1020 associated with an aircraft, a route, an airport, or otherwise. In some cases, historical flight data may indicate that an aircraft, while not specifically following a filed flight plan, may nevertheless by taking a route that is flown regularly and many not be considered anomalous.

The remote computer resources 1002 may use the input data, by executing one or more modules, to perform machine learning on the input data, such as to determine a threat score for each aircraft. In some cases, this requires performing machine learning and determining threat scores on tens of thousands of aircraft flights each day. In some cases, a threat score is determined on each aircraft in an increment, such as thirty seconds, one minute, two minutes, five minutes, ten minutes, or some other increment. Therefore, the EDT system 100 may determine tens of millions of threat scores each day for thousands of aircraft flying over the United States.

The remote computing resources 1002 may further execute one or more modules 1010 that provide a user interface, which can be accessed by a user device 1012 associated with a user 1014. The user interface may allow a user 1014 to quickly visualize the aircraft posing the highest threat level at any given time, and in any geographic location. In some cases, the user interface may be filtered by geography, such that a user may chose to view aircraft within certain airspace, a certain state, or within a geoboundary around a specified location.

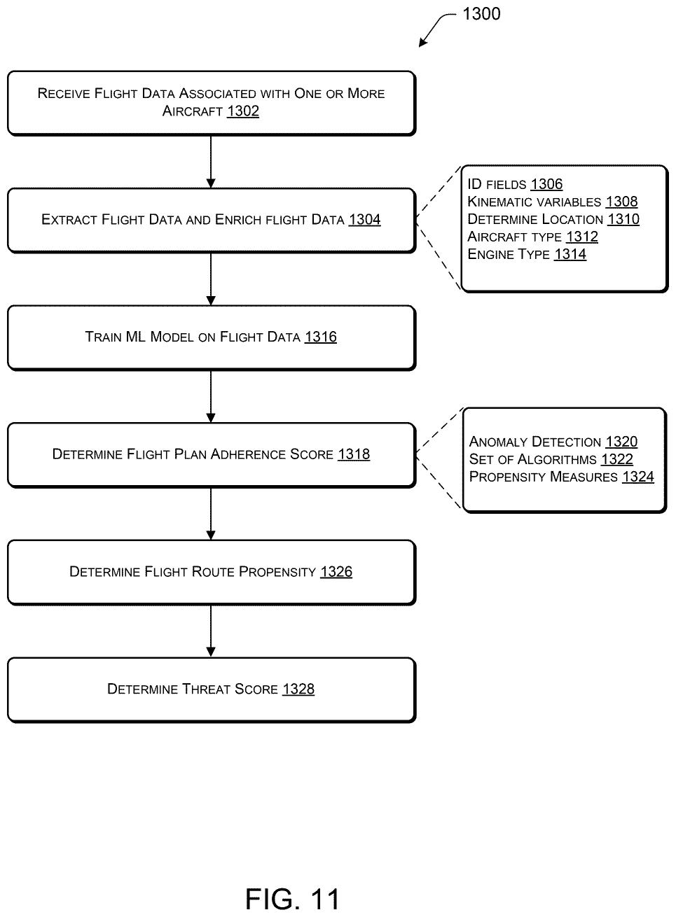

FIG. 11 illustrates a process flow 1300 for determining a threat score of an anomalous aircraft by an aircraft early detection of threats system. At block 1302, the system receives flight data associated with one or more aircraft. In some cases, the system receives flight data for hundreds, thousands, or tens of thousands of aircraft, much of which may be simultaneously. The flight data for a single aircraft may be received in regular increments, such as every ten seconds, every thirty seconds, one minute, every two minutes, every five minutes, or some other interval.

At block 1304, the system extracts flight data and enriches the flight data 1304. This may further include feature generation, as described herein, timescale scoring as described herein, and overall scoring, as described elsewhere herein. The data extraction may include determining one or more ID fields 1306 associated with an aircraft, determining kinematic variables associated with a flight of the aircraft 1308, and determining a location of the aircraft 1310. The data may be enriched, such as by determining the aircraft type 1312, the engine type 1314, as well as other information, such as performance characteristics of the particular aircraft and engine type.

At block 1316, a machine learning model is trained on flight data in order to determine anomalous aircraft behavior. This may include dataset routing, dataset sinks, server-side scripts, and machine learning model activation, as described herein.

At block 1318, the machine learning model may be used to determine a flight plan adherence score 1318. This may include determining flight plan adherence estimates. As described herein, a flight plan may be segregated into discrete straight lines between sequences of long-lat points and determine the deviation of the aircraft from the straight line path between long-lat pairs. This step may perform anomaly detection 1320 which may be based, at least in part, on a deviation of an aircraft from its flight plan. A set of algorithms 1322 may be used to determine the deviation and, thus, the flight plan adherence. In addition, propensity measures 1324 may be used in predicting and determining the flight plan adherence score.

At block 1326, the system determines flight route propensity 1326, which may be used to estimate the component probabilities from flight messages. In some cases, naive bayes classification is used to estimate and infer anomalies from flight messages. The system may further use one or more of one-class classification, empirical probability estimates, recursive windowing, windowed probability estimates, single sector propensity, normalized sector propensity, region-scaled propensity, alignment across regions, and measure smoothing in determining the flight route propensities.

At block 1328, the system determines a threat score. Accordingly, the machine learning workflows described will classify, identify, and surface suspicious activity to human operators. The operators can then review alerts and escalate or mark the alerts as false. In some cases, the suspicious activity will be provided on a user interface that can quickly disseminate information to the appropriate operator to take further action based on the information provided.

The disclosure, which includes all application documents submitted herewith, sets forth example embodiments and, as such, is not intended to limit the scope of embodiments of the disclosure and the appended claims in any way. Embodiments have been described with the aid of functional building blocks illustrating the implementation of specified functions and relationships thereof. The boundaries of these functional building blocks have been arbitrarily defined herein for the convenience of the description. Alternate boundaries can be defined to the extent that the specified functions and relationships thereof are appropriately performed. Moreover, embodiments may use any suitable combination of functional building blocks described throughout and the example embodiments are provided to aid in understanding of general and specific use cases for the disclosed technology and embodiments thereof.

The foregoing description of specific embodiments will so fully reveal the general nature of embodiments of the disclosure that others can, by applying knowledge of those of ordinary skill in the art, readily modify and/or adapt for various applications such specific embodiments, without undue experimentation, without departing from the general concept of embodiments of the disclosure. Therefore, such adaptation and modifications are intended to be within the meaning and range of equivalents of the disclosed embodiments, based on the teaching and guidance presented herein. The phraseology or terminology herein is for the purpose of description and not of limitation, such that the terminology or phraseology of the specification is to be interpreted by persons of ordinary skill in the relevant art in light of the teachings and guidance presented herein.

The breadth and scope of embodiments of the disclosure should not be limited by any of the above-described example embodiments, but should be defined only in accordance with the following claims and their equivalents.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

Unless otherwise noted, the terms “connected to” and “coupled to” (and their derivatives), as used in the specification, are to be construed as permitting both direct and indirect (i.e., via other elements or components) connection. In addition, the terms “a” or “an,” as used in the specification, are to be construed as meaning “at least one of.” Finally, for ease of use, the terms “including” and “having” (and their derivatives), as used in the The specification and drawings disclose examples of systems, apparatus, devices, and techniques that may provide control and optimization of separation equipment. It is, of course, not possible to describe every conceivable combination of elements and/or methods for purposes of describing the various features of the disclosure, but those of ordinary skill in the art recognize that many further combinations and permutations of the disclosed features are possible. Accordingly, various modifications may be made to the disclosure without departing from the scope or spirit thereof. Further, other embodiments of the disclosure may be apparent from consideration of the specification and annexed drawings, and practice of disclosed embodiments as presented herein. Examples put forward in the specification and annexed drawings should be considered, in all respects, as illustrative and not restrictive. Although specific terms are employed herein, they are used in a generic and descriptive sense only, and not used for purposes of limitation.

Those skilled in the art will appreciate that, in some implementations, the functionality provided by the processes and systems discussed above may be provided in alternative ways, such as being split among more software programs or routines or consolidated into fewer programs or routines. Similarly, in some implementations, illustrated processes and systems may provide more or less functionality than is described, such as when other illustrated processes instead lack or include such functionality respectively, or when the amount of functionality that is provided is altered. In addition, while various operations may be illustrated as being performed in a particular manner (e.g., in serial or in parallel) and/or in a particular order, those skilled in the art will appreciate that in other implementations the operations may be performed in other orders and in other manners. Those skilled in the art will also appreciate that the data structures discussed above may be structured in different manners, such as by having a single data structure split into multiple data structures or by having multiple data structures consolidated into a single data structure. Similarly, in some implementations, illustrated data structures may store more or less information than is described, such as when other illustrated data structures instead lack or include such information respectively, or when the amount or types of information that is stored is altered. The various methods and systems as illustrated in the figures and described herein represent example implementations. The methods and systems may be implemented in software, hardware, or a combination thereof in other implementations. Similarly, the order of any method may be changed and various elements may be added, reordered, combined, omitted, modified, etc., in other implementations.

As used herein, the terms “about” and “approximately” may, in some examples, indicate a variability of up to ±5% of an associated numerical value, e.g., a variability of up to ±2%, or up to ±1%.

According to some example embodiments, the systems and/or methods described herein may be under the control of one or more processors. The one or more processors may have access to computer-readable storage media (“CRSM”), which may be any available physical media accessible by the processor(s) to execute non-transitory instructions stored on the CRSM. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other non-transitory medium which can be used to store the desired information and which can be accessed by the processor(s). In some cases, embodiments utilize, rely, incorporate, or create instructions, which when executed by the one or more processors, cause a computer system to perform acts, such as those described throughout.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

From the foregoing, it will be appreciated that, although specific implementations have been described herein for purposes of illustration, various modifications may be made without deviating from the spirit and scope of the appended claims and the elements recited therein. In addition, while certain aspects are presented below in certain claim forms, the inventors contemplate the various aspects in any available claim form. For example, while only some aspects may currently be recited as being embodied in a particular configuration, other aspects may likewise be so embodied. Various modifications and changes may be made as would be obvious to a person skilled in the art having the benefit of this disclosure. It is intended to embrace all such modifications and changes and, accordingly, the above description is to be regarded in an illustrative rather than a restrictive sense.

While the disclosure discusses utilizing ADS-B-OUT data for determining a position of an aircraft, it should be understood that other forms of data and other data sources or combinations of data sources may be used to determine positional information, such as for example, multilateration (MLAT), radar, air navigation service providers (ANSPs), ACARS Datalinks which may be VHF, SATCOM, or otherwise, flight information (FLIFO) from airline service systems, satellite based systems, space-based ADS-B networks, visual systems, pilot reports (PIREPS), and other data sources and forms.

What is claimed is:

1. A method for determining aircraft threats, comprising:
receiving flight data associated with one or more aircraft;
extracting and enriching the flight data;
training machine learning (ML) models on the flight data;
determining flight route propensities;
determining a threat score;
generating an alert where a threat score exceeds a threshold; and
displaying the threat score and the alert on a user interface.

2. The method of claim 1, wherein the flight data includes one or more of Automatic Dependent Surveillance-Broadcast (ADS-B) data, filed flight plan data, and Federal Aviation Administration tables.

3. The method of claim 1, wherein enriching the flight data includes adding one or more of an aircraft location, an aircraft type, an engine type, and aircraft performance characteristics to the flight data.

4. The method of claim 1, wherein determining the flight route propensities comprises a Bayesian classifier.

5. The method of claim 1, wherein training machine learning models comprises training an ML model unique to a combination of an aircraft type and an engine type.

6. The method of claim 1, wherein receiving flight data associated with one or more aircraft comprises receiving flight data on a time interval for an operating flight.

7. The method of claim 6, wherein the time interval is every 10 seconds.

8. The method of claim 1, wherein receiving flight data associated with one or more aircraft comprises receiving flight data for over 1000 aircraft simultaneously.

9. The method of claim 1, wherein determining a threat score is performed in near real time.

10. The method of claim 1, wherein extracting and enriching the flight data comprises generating Kafka topics.
